(19) United States
(12) Patent Application Publication
(10) Pub. No.: US 2006/0238328 A1
(43) Pub. Date: Oct. 26, 2006

(54) Method for call billing communication connections between communication terminals in separate, packet-switched communication networks

(75) Inventor: Uwe Foll, Falkensee (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/553,053

(22) PCT Filed: Apr. 8, 2004
(86) PCT No.: PCT/DE04/00795

§ 371 Date: Oct. 12, 2005

(30) Foreign Application Priority Data
May 2, 2003 (EP) 03101212.3

(51) Int. Cl. G08B 26/00

(52) U.S. Cl. 340/505

(57) ABSTRACT

The invention relates to a method for call billing a communication link established between a first communication terminal of a first packet-switched communication network and a second communication terminal of a second packet-switched communication network. A request message for establishing the communication link is conveyed from the first communication terminal or from the second communication terminal to a transition node arranged between the first and the second communication network. The request message is conveyed again from the transition node to an evaluation and control unit, said evaluation and control unit evaluating the request message with respect to the origin thereof and normally determining whether the communication connection which is to be established is billed or is treated without billing and call billing is carried out in a manner corresponding to a call charge computer.

The present invention relates to a method for call billing for a communication connection between a first communication terminal in a first packet-switched communication network and a second communication terminal in a second packet-switched communication network. The case which is of particular interest here is when the first packet-switched communication network is the Internet. For the purpose of utilizing the possibilities of the Internet, communication devices such as, for example, laptops, computers, PDAs or mobile telephones, are connected to the Internet, using various technologies such as for example dial-up telephone connections, fixed lines or satellite connections. In future, with the ongoing development of mobile radiocommunication networks, in particular the third generation of these (GPRS=general packet radio service, UMTS=universal mobile telecommunications service), various items of data will be routed from the Internet to such communication terminals. For the use of mobile radiocommunication resources, the operators of the mobile radiocommunication networks will demand a payment, for example in the form of communication charges.

One method for charging for a communication connection between communication terminals connected to the Internet and mobile destination communication terminals is already known from European patent application EP 02090124. For this, the exact treatment of the packets which are to be transported in a communication connection of this type is left open.

A communication connection between two different packet-switched communication networks is always packet-oriented. In this case, the communication networks can be, for example, mobile radiocommunication networks working on a packet-oriented basis, or one of the two may also be the Internet. Since a communication connection in this case is not made on a circuit-switched basis but is packet-oriented, an interface node between the two networks has no control over a continuous transaction in or from one of the two directions, but each individual packet which is transported must be separately analyzed. For the recording of packets for charging purposes the problem arises that each packet which passes the interface node must be identified in terms of its origin, that is the direction or packet-switched communication network from which the packet is coming, as applicable.

One object of the present invention was thus to provide a method with which communication connections, between communication terminals in a first packet-switched communication network and communication terminals in a second packet-switched communication network, can be securely and reliably identified in respect of their initiation, and appropriately charged.

This object is achieved in accordance with the invention by a method in accordance with claim 1. Further preferred forms of embodiment of the method in accordance with the invention are set out in the subclaims.

In accordance with claim 1, a method is provided for charging a communications connection which is set up between a first communication terminal in a first packet-switched communication network and a second communication terminal in a second packet-switched communication network, whereby a set-up request message concerning the communication connection is routed from the first communication terminal or the second communication terminal to an interface node between the first and the second communication networks, this set-up request message is forwarded by the interface node to an analysis and control unit, this analysis and control unit analyzes the set-up request message in respect of its origin and specifies by a rule whether the communication connection concerned which is to be set up will be treated as chargeable or charge-free. The charges will be levied accordingly via a billing computer.

The analysis and control unit has functionality which can record the connection set-up request message and analyze it with respect to the direction from which the message is coming, that is its origin. Using the direction from which the connection set-up request message is coming, it is possible to determine the initiator of the communication connection. By reference to its knowledge of the initiator of the communication connection, the analysis and control unit now specifies a rule as to whether the communication connection concerned which is to be set up is to be treated as chargeable or charge-free.

In one particularly preferred form of embodiment of the method in accordance with the invention, the analysis and control unit forwards the specified rule to all the interface nodes which are involved in the recording of the packets which are to be transported for the communication connection concerned. As a result, the packets will be ignored by the interface nodes if the communication connection is being treated as charge-free according to the rule. On the other hand, if the communication connection is chargeable according to the rule, then the packets will be recorded by the interface nodes and corresponding charges will be levied via the billing computer. In general there is no guarantee that the signaling data and the user data for a communication connection which is to be set up are transported through the same interface node. It is therefore important that all the interface nodes which are involved in the recording of the packets to be transported for the communication connection concerned know of the initiator of the communication connection and the associated ruling on charges. In accordance with the invention, this is ensured by forwarding the rule to all interface nodes affected.

Preferably, the first communication network used will be the Internet. This means that a communication connection is set up between a communication terminal which is connected to the Internet and a second communication terminal in a packet-switched network. Here, the use of a mobile radiocommunication network which works on a packet-switched basis is especially preferred as the second communication network. This scenario is especially interesting because, with the ongoing development of the third generation of mobile radiocommunication networks, ever more data is being transmitted from communication terminals connected to the Internet to destination communication terminals connected to mobile radiocommunication networks. Here, the destination communication terminals can be, for example, mobile telephones, laptops or PDAs with mobile radiocommunication interfaces. Communication terminals connected to the Internet can be, for example, computers, laptops, PDAs or mobile telephones, connected to the Internet using various technologies such as for example dial-up telephone connections, fixed lines or satellite connections.

Here, the first communication terminal which is connected to the Internet can be connected to the Internet via an Internet access network. By this means, it is possible advantageously to make use of communication terminals which cannot be directly connected to the public Internet but for which the access to the Internet is effected via one or more intermediate access networks.

In a further preferred form of embodiment of the method in accordance with the invention, it is further possible for the communication connection between the first communication terminal and the second communication terminal also to be set up via the Internet. This means that the Internet is acting here merely as an interface network.

If the first communication network is the Internet and the second communication network is a mobile radiocommunication network, then the interface node represents a connecting node, connecting the Internet to the mobile radiocommunication network. Accordingly, the connecting node (gateway) represents a type of “entry node” or “first node” for the radio-communication network. Here, it is particularly advantageous if the connecting node requests the set-up request message to the analysis and control unit, for the purposes of analysis and the specification of a rule about the charging, at a point in time when a connection between the networks is initially being created, that is, right at the start of the set-up of a communication connection between the networks. By this means it will be clear, from the start of the procedure to set up the communication connection, how the packets which are to be transported on the communication connection are to be handled in terms of charging.

In a preferred form of embodiment of the method in accordance with the invention, the element used as the interface node is a data packet control system which controls connection set-ups.

In a particularly preferred form of embodiment of the method in accordance with the invention, the analysis and control unit is integrated into an interface node. The advantage of this is that no new unit needs to be generated, but it is efficient in that it is only necessary to incorporate additional functionality into a node.

If the second communication network is a mobile radio-communication network, then it is advantageous to use a network computer of the mobile radiocommunication network as the billing computer. Such an arrangement of the method in accordance with the invention has the particular advantage that the communication between the interface node and the network computer of the mobile radiocommunication network takes place within the mobile radiocommunication network. This makes possible data transmission is which is particularly secure or protected against eavesdropping which, on the one hand, contributes to the high security requirements of billing methods and, on the other hand, ensures that data is protected in a particularly good way.

The network computer can be arranged, for example, in the data control system.

If the Internet is used as the second communication network it is also possible, in a particularly preferred form of embodiment of the method in accordance with the invention, to utilize an Internet computer on the Internet as the billing computer. It is here advantageously possible to use an Internet computer available on the Internet as a billing computer. For this purpose it is possible, for example to use the services of an Internet service provider. By this means, the method can be more cheaply realized than with the installation of a special billing computer.

In a preferred form of embodiment of the method in accordance with the invention, after the rule specified by the analysis and control unit has been forwarded to all the interface nodes which are involved in the recording of the packets which are to be transported for the communication connection concerned, it is stored in the interface nodes. By this means, the interface nodes will have information for the duration of the communication connection about how to proceed with the packets transported on it. A one-time forwarding to all the interface nodes of the rule specified by the analysis and control unit is sufficient to define the charging for the entire communication connection. This is very efficient and hence low cost. The interface nodes know the initiator of the communication connection and the associated charging, specified by the rule. The rule is made up of general and connection-specific parts.

In a preferred form of embodiment of the method in accordance with the invention, for the purpose of terminating the connection one of the communication terminals transmits an end message, which is analyzed by the analysis and control unit. The rule is then canceled. Furthermore, the analysis and control unit transmits to all the interface nodes affected a message specifying the invalidity of the rule. Thereafter, any packets between the communication terminals for the former communication link will no longer be handled in accordance with the earlier rule.

In a further preferred form of embodiment of the method in accordance with the invention, an interface is provided between the analysis and control unit and the billing computer. This enables the analysis and control unit to inform the billing computer directly about the ruling on charges.

This is significantly more efficient than indirect information via one or more interface nodes.

Further advantages of the method in accordance with the invention are to be explained in more detail by reference to the figure below. This shows:

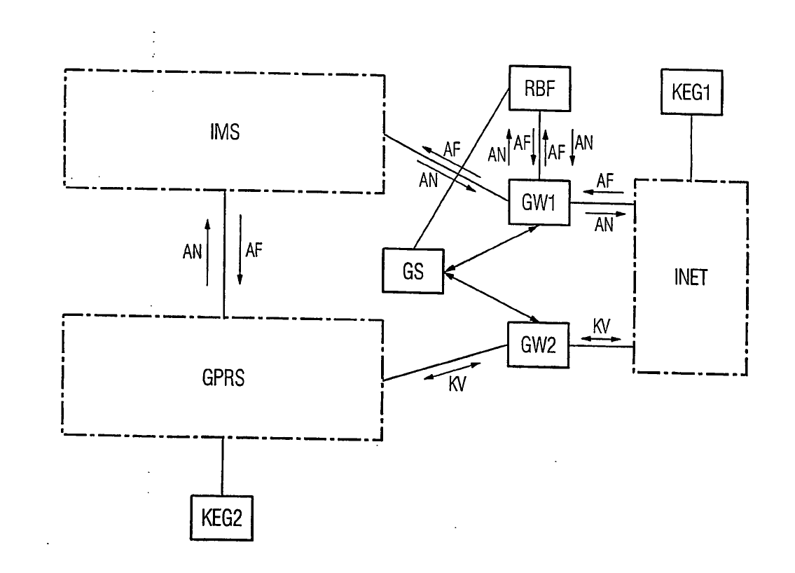

FIG. 1 schematic diagram of an exemplary embodiment of the progress of the method in accordance with the invention.

On the right hand side of FIG. 1 is shown a communication terminal KEG1. This could be, for example, a computer. This communication terminal KEG1 is connected to the Internet INET via an Internet access network. No details are shown of the Internet itself. There are, of course, numerous switching processors in the Internet, and Internet computers connected to these switching processors. Two interface nodes (gateways) GW1 and GW2 are shown connecting to the Internet INET. One of the interface nodes, in this case GW1, is connected to an analysis and control unit RBF (rule determining function). The analysis and control unit RBF is in addition connected to a billing computer GS via an interface. Both the interface nodes GW1 and GW2 are likewise connected to the billing computer GS. The interface nodes GW1 and GW2 are in addition connected to a mobile radiocommunication network MFN. The portion of the mobile radiocommunication network MFN shown here contains a data packet control system IMS (IMS=IP Multimedia Subsystem, IP=Internet Protocol). The data packet control system IMS is connected to a data transmission system GPRS. This exemplary embodiment thus shows a third generation mobile radiocommunication network which works in accordance with the GPRS specification (GPRS=General Packet Radio System). Finally, a second communication terminal KEG2 is shown linked to the mobile radiocommunication network MFN; in this case it is a mobile telephone.

A data packet control system IMS generally serves to control packet-based multimedia for mobile communication networks. The control system IMS enables multimedia services to be provided both for the mobile access network and also for the Internet. The control functions are effected using a protocol called a “session initiation protocol” (SIP). This generic protocol can then be used to control both the set-up of connections for subscribers within the mobile radiocommunication network and also the set-up of connections between subscribers to the radio communication network and subscribers to the Internet. Control of the connections is then effected via a so-called “call state control function” (CSCF), which represents a component of the control system IMS.

Suppose a communication connection KV is now to be set up between the two communication terminals KEG1 and KEG2. Now, depending on which communication terminal initiates the communication connection KV, a set-up request message AF is transmitted from that terminal. In the situation shown here, communication terminal KEG1 initiates a communication connection via the Internet INET, and accordingly transmits a set-up request message AF via the gateway GW1 to the mobile radiocommunication network MFN, or via the mobile radiocommunication network's data control system IMS onward to the data transmission system GPRS, as applicable. The set-up request message AF arrives first at the gateway GW1. It is only possible to determine the initiator of the communication connection KV by reference to the direction from which the set-up request message comes. In order to determine the direction from which the set-up request message AF came, the set-up request message AF is, in accordance with the invention, sent to the analysis and control unit RBF. The set-up request message AF contains data about the communication connection KV which is to be set up and about the participants in the communication KEG1 and KEG2, which are characterized by appropriate IP addresses. For the communication connection KV which is to be set up, the analysis and control unit RBF now specifies, by reference to the items of data which are contained in the set-up request message AF, how the packets for this communication connection KV are to be dealt with. This means that the RBF then specifies whether the packets are to be recorded for billing by GW1 or GW2 or not. For example, the RBF can specify that if the communication connection KV is initiated by the Internet subscriber KEG1, all the packets for this communication connection KV should be recorded by the gateways; if the communication connection KV has been initiated by the mobile telephone KEG2, the packets for this communication connection KV are to be ignored by the gateways. After the rule has been specified by the analysis and control unit RBF, the rule is distributed by the analysis and control unit RBF to all the gateways involved in the communication connection, in this case GW1 and GW2. When this is done, the address of GW1 is known to the analysis and control unit RBF, because it was through this that the set-up request message AF was transmitted to the analysis and control unit RBF. The analysis and control unit RBF can determine the address of the second gateway GW2 from the IP address of the mobile telephone, which is communicated to the analysis and control unit RBF with a reply message AN from the mobile telephone. After the rule has been received, this rule is stored by the gateways. In order to terminate the communication connection KV, one of the two communication terminals KEG1 or KEG2, or the corresponding subscriber, as applicable, transmits an end message EN. This end message EN is analyzed by the analysis and control unit RBF. The analysis and control unit RBF then transmits an indication to the gateways GW1 and GW2, specifying the invalidity of the rule. The two gateways GW1 and GW2 then ignore all the packets for the communication connection KV previously set up between the IP addresses of the communication terminals KEG1 and KEG2. For efficiency of application, it may be logical for the analysis and control unit RBF to have an interface to the billing computer GS, as shown here. It can also be logical, for the purpose of reducing complexity, to route the entire traffic for a communication connection KV through exactly one gateway. To this end, the analysis and control unit RBF could, for example, set the address of the first gateway GW1 in the header of the set-up request message AF, thereby requesting the communication network to route all packets via the first gateway GW1.

1. Method for call charging for a communication connection which is set up between a first communication terminal in a first packet-switched communication network and a second communication terminal in a second packet-switched communication network, in which
from within the first communication terminal or from within the second communication terminal a set-up request message concerning the communication network is routed to an interface node between the first and the second communication network,
the set-up request message is forwarded from the interface node to an analysis and control unit,
the analysis and control unit analyzes the set-up request message with respect to its origin and specifies by a rule whether the communication connection concerned which is to be set up will be charged or treated as charge-free,
the billing is undertaken correspondingly via a billing computer.

2. Method in accordance with claim 1,
characterized in that
the analysis and control unit forwards the rule which has been specified to all interface nodes which are involved in the recording of the packets which are to be transported for the communication connection concerned,
the packets are ignored by the interface nodes if, according to the rule, the communication connection concerned is to be treated as charge-free,
the packets are recorded by the interface node, and corresponding billing is effected via the billing computer, if the communication connection concerned is, according to the rule, chargeable.

3. Method in accordance with claim 1,
characterized in that
the Internet is used as the first communication network.

4. Method in accordance with claim 1,
characterized in that
a mobile radiocommunication network working on a packet-oriented basis is used as the second communication network.

5. Method in accordance with one of the preceding claims 1,
characterized in that
the communication connection between the first communication terminal and the second communication terminal is set up via the Internet.

6. Method in accordance with claim 1,
characterized in that
an element of a data packet control system which controls connection set-ups is used as the interface node.

7. Method in accordance with claim 1,
characterized in that
the analysis and control unit is integrated into an interface node.

8. Method in accordance with claim 4,
characterized in that
a network computer of the mobile radiocommunication network is used as the billing computer.

9. Method in accordance with claim 3,
characterized in that
an Internet computer of the Internet is used as the billing computer.

10. Method in accordance with claim 1,
characterized in that
the rule is stored in the interface nodes.

11. Method in accordance with claim 1,
characterized in that
all packets for the communication connection are routed via a special interface node.

12. Method in accordance with claim 1,
characterized in that
after termination of the connection one of the subscribers transmits an end message, the end message is analyzed by the analysis and control unit, the rule is canceled and the interface nodes are notified of this.

13. Method in accordance with claim 1,
characterized in that
an interface is provided between the analysis and control unit and the billing computer.
